(19) United States
(12) Patent Application Publication
(10) Pub. No.: US 2026/0252451 A1
(43) Pub. Date: Aug. 27, 2026

(54) SIMPLIFIED VALIDATION STRATEGIES USING ONE OR MORE VALIDATION PANEL SYSTEMS

(71) Applicant: DELL PRODUCTS L.P., Round Rock, TX (US)

(72) Inventor: Yayun LIU, Austin, TX (US)

(73) Assignee: DELL PRODUCTS L.P., Round Rock, TX (US)

(21) Appl. No.: 19/060,497

(22) Filed: Feb. 21, 2025

(51) Int. Cl. G06F 11/22

(52) U.S. Cl. CPC G06F 11/2289

(57) ABSTRACT

As the size and complexity of datacenters increase, so too does the complexity in building and testing the deployment. Being able to test (i.e., validate) such large-scale deployments is becoming complicated by the physical size and increased complexity. The number and size of testing equipment and cabling is not only costly and cumbersome, the also presents other risks, such as safety, accuracy issues, and efficiency. Presented herein are embodiments of a validation panel system that allows for validation testing with less equipment, far fewer cabling connections (if any at all), and can facilitate validation testing without using any native network wiring of the datacenter. In some cases, the network wiring infrastructure may not yet exist or may not be dependable enough to use. By bypassing the racks'network wiring infrastructure (if it exists yet), validation can be performed faster and more efficiently.

### BACKGROUND

### A. Technical Field

The present disclosure relates generally to information handling systems. More particularly, the present disclosure relates to systems and methods for simplifying validation of deployments, particularly in large-scale deployment environments.

### B. Background

The subject matter discussed in the background section shall not be assumed to be prior art merely as a result of its mention in this background section. Similarly, a problem mentioned in the background section or associated with the subject matter of the background section should not be assumed to have been previously recognized in the prior art. The subject matter in the background section merely represents different approaches, which in and of themselves may also be inventions.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The ever-increasing development and use of machine learning and artificial intelligence (ML/AI) applications have created a dramatic increase in demand for computing resources and processing resources. With increasingly complex ML/AI models, more and more processing systems are needed.

Thus, the exponentially growing complexity of ML/AI models and their ever-growing voracious need for data have created needs for datacenters with vast numbers of processing units and supporting infrastructure. The supporting infrastructure, including information handling systems, such as network switches, and cabling, have also become more complex and more closely tied to the ML/AI deployment. For example, in addition to needing large numbers of complex processing information handling systems, cabling and network topology are also increasing in complexity.

As the size and complexity of these datacenters increase, so too does the complexity in building and testing the deployment. The large-scale deployments suffer from such rudimentary logistical issues such as physical size. Being able to test such large-scale deployments is becoming complicated by the physical size and increased complexity.

Accordingly, it is highly desirable to find new, simpler, and more efficient ways to validate deployments in datacenters, particularly large-scale datacenter environments.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

FIG. 1 (“FIG. 1”) depicts a validation cart as used by an onsite deployment team.

FIG. 2 depicts a traditional rack configuration versus a rack with a validation panel, according to embodiments of the present disclosure.

FIG. 3 depicts major components of a validation panel, according to embodiments of the present disclosure.

FIG. 4 depicts a set of connected validation panels, according to embodiments of the present disclosure.

FIG. 5 depicts an alternative configuration of a set of connected validation panels, according to embodiments of the present disclosure.

FIG. 6 depicts a methodology for validating a deployment using one or more validation panels, according to embodiments of the present disclosure.

FIG. 7 depicts communication from a validation panel to a target server in a rack, according to embodiments of the present disclosure.

FIG. 8 depicts a simplified block diagram of an information handling system, according to embodiments of the present disclosure.

FIG. 9 depicts an alternative block diagram of an information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” shall not be interpreted as limiting embodiments of the present invention to Layer 2 networks; and, the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

In one or more embodiments, a stop condition may include: (1) a set number of iterations have been performed; (2) an amount of processing time has been reached; (3) convergence (e.g., the difference between consecutive iterations is less than a first threshold value); (4) divergence (e.g., the performance deteriorates); and (5) an acceptable outcome has been reached.

It shall also be noted that although embodiments described herein may be within the context of large-scale datacenter environments and in systems on a rack or racks, aspects of the present disclosure are not so limited. Accordingly, the aspects of the present disclosure may be applied or adapted for use in other contexts.

### A. General Introduction

The growing complexity and size of datacenters has made it increasingly more difficult to validate the builds of these large-scale datacenters. For example, xAI's Colossus project is a significant deployment, which is claimed to be the world's largest AI datacenter once it is finished being built. The project, valued in the billions of dollars, involves massive deployment of complex systems.

Part large-scale deployments may include Dell equipment, such as its air-cooling XE9680 solution, which is a high-performance application server for artificial intelligence, machine learning, and deep learning with up to two Intel Xeon Scalable processors and eight NVIDIA or AMD GPUs. A large-scale deployment could include over 12,000 of such servers, each equipped with 8 Nvidia H100 GPUs, totaling almost 100,000 GPUs. The sheer magnitude of such a datacenter evidences the complexity of trying to build and validate such a network.

For large scale deployments, the datacenter may be considered a compilation of a set of smaller subunits. For example, a datacenter may be made of a number of smaller units, which may be called a scalar unit (SU). In one or more embodiments, a scalar unit may comprise 8 racks, each with 8 servers (e.g., XE9680 servers), and the datacenter or data hall may comprise 64 SUs.

In one or more embodiments, a validation process may include a set of one or more tests, such as Build Verification, SBR (Secondary Bus Reset), and one or more quality assurance tests, such as Integrated Silicon Test (IST) and Nvidia GPU field diagnostics. These tests are conducted on-site and can take several hours (e.g., up to 12 hours) to complete.

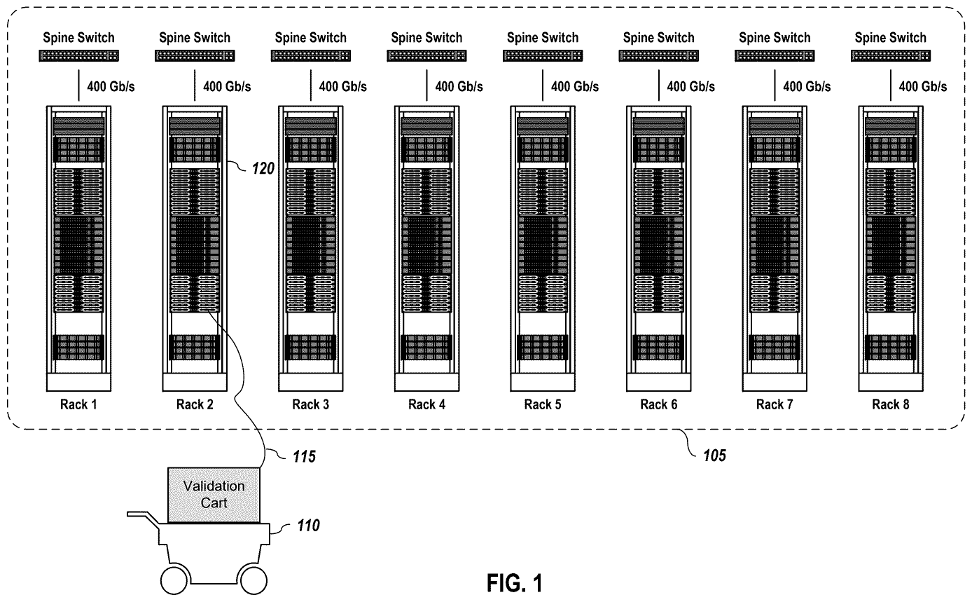

To perform validation, a validation strategy may employ a validation cart, which is graphically depicted in FIG. 1 as item 110. A validation cart 110 may comprise a mobile cart that includes a validation server (e.g., an R640-type server), two network switches (e.g., two 1G switches), and 64 or 128 RJ45 cables. The validation cart may test a set of information handling systems (e.g., servers), such as all the servers on a rack (e.g., rack 120) or a set of racks (e.g., set of racks 105). To perform validation tests, cables 115, such as RJ45 cables, run from the validation cart 110 to the servers that are to be tested.

To effectively and quickly test a large datacenter, often a number of validation carts are deployed in parallel. For example, 48 validation carts may be deployed. Such a deployment requires 48 portable carts, 48 validation servers, 96 switches, thousands of RJ45 cables, and power sources for each cart. Not only is such a deployment costly, but it is logistically problematic for several reasons.

Moving the validation carts is challenging due to their weight. Their weight and cabling also poses safety hazards. Also, while a datacenter can be physically large, having that many validation carts and the personnel to operate them all at one location can create congestion and safety risks. Furthermore, the connecting of all the cables, ensuring that they are connected correctly, and then removing the cable connections after validation to move to the next set of rack information handling systems is extremely labor intensive and fraught with potential cabling errors and safety hazards.

It should be noted that part of the problem of validating a new or even an upgraded deployment is that the validation team cannot use the existing fabrics of the datacenter for a number of reasons.

First, there is an issue of domain and control. Often, multiple third-party companies manage cabling at a single datacenter site—particularly at large installations. Because the validation company may not have control over all the cabling or even know when it is installed or operational, it may not be possible to use the fabric. Second, the owner of the datacenter may set restrictions or constraints on the validation service team. For example, the validation team may not be permitted to utilize any of the existing infrastructure aside from the servers. Given such constraints, the validation team may have very limited access to the customer's infrastructure to perform their testing. Accordingly, presented herein are embodiments for efficient validation for an onsite service and deployment team. Embodiments reduce complexity and cost, increase safety, streamline the validation process, and help ensure timely delivery to the customer.

### B. Validation Panel Embodiments

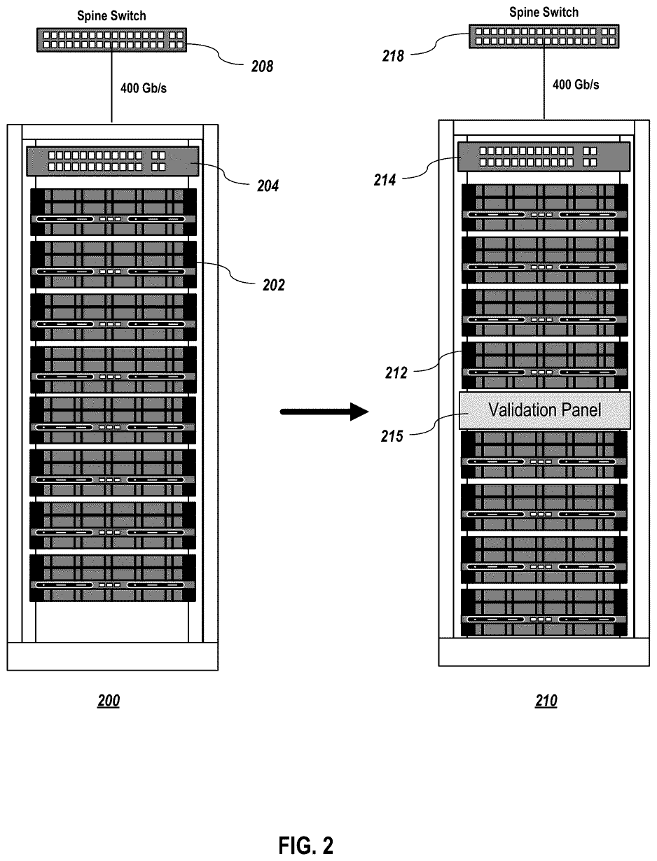

To address the validation issues discussed above, presented herein are embodiments involving a validation panel that may be used to validate information handling systems in a deployment. FIG. 2 depicts a traditional rack 200 and a rack 210 with a validation panel 212, according to embodiments of the present disclosure.

A traditional rack 200 may comprise a number of information handling systems 202. In this depicted example, there are eight (8) servers and a leaf switch 204. The leaf switch 204 connects to one or more spine switches 208. The rack 210 also includes eight (8) servers 212 and a leaf switch 214 that connects to one or more spine switches 218. However, the rack 210 includes a validation panel 215.

In the depicted embodiment, the validation panel 215 may take a rack space. However, it shall be noted that a validation panel 215 may be implemented in any of a number of different form factors and deployed in a number of different ways. In one or more embodiments, the validation panel may take less than one rack unit of space. In one or more embodiments, the validation panel may not take any rack space. For example, a validation panel may be connected in front of another piece of equipment on the rack. In yet other alternative embodiments, the wireless features of the validation rack, which are explained in more detail below, allow the validation rack to be held by a user or temporarily hung on the rack while testing.

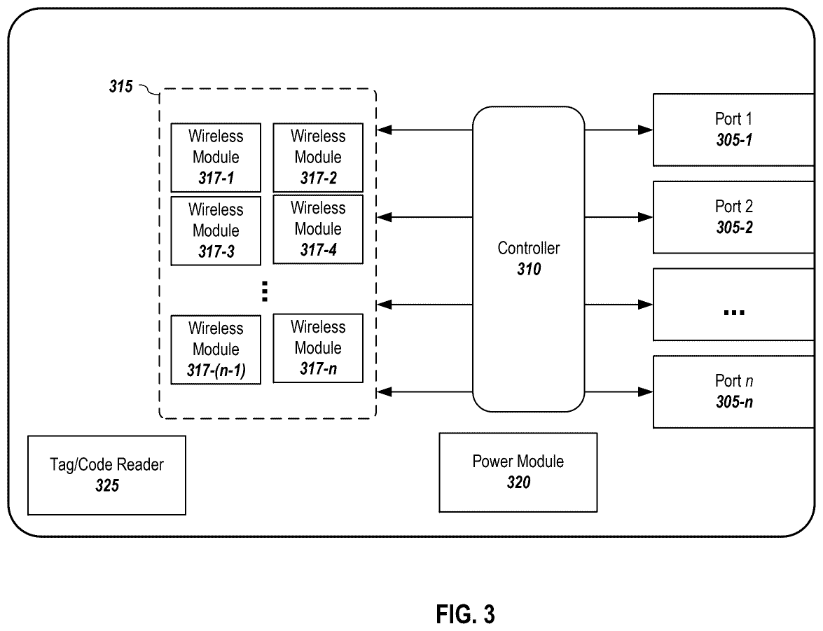

FIG. 3 depicts modules of a validation panel, according to embodiments of the present disclosure. In one or more embodiments, a validation panel may comprise five major components.

In one or more embodiments, the validation panel 300 includes a communications module 315 that comprises a set of wireless modules 317. For example, the communications module 315 may comprise a number of Bluetooth and/or WiFi modules 317 (although other wireless protocols may be additionally or alternatively supported). In one or more embodiments, the number of wireless modules may relate to the number of information handling systems that are to be validated in a batch, in which one wireless module is dedicated to communicating with one information handling system. For example, the validation panel may be configured to test a set of information handling systems on a rack and there is a wireless module for each information handling system that is being validated in the rack. Using the rack 210 depicted in FIG. 2 by way of illustration, the validation panel may include at least eight (8) wireless modules—one for each server 212. In one or more alternative embodiments, the validation panel may also include a wireless module for additional equipment, such as the leaf switch 214. In one or more embodiments, fewer wireless modules may be used, in which a wireless module is shared between two or more information handling systems that are being validated.

As illustrated, the validation panel 300 may comprise one or more physical network ports 305, which are communicatively coupled to a controller 310. The ports 305 may be used to connect to an information handling system, including a server that is being validated, a peer validation panel, and/or a computer being operated by a validation tester or administrator. In one or more embodiments, there may not be any network ports, and the validation panel may only connect wirelessly to other information handling system(s), such as server(s) or other validation panel(s).

Returning to FIG. 3, the validation panel 300 comprises a controller/MCU (microcontroller unit) that orchestrates communication between the communications module 315 and one or more external networks. In one or more embodiments, the controller 310 may comprise non-volatile processor/controller-readable medium or media comprising one or more sets of instructions which, when executed by the controller, causes steps to be performed. Discussion of embodiments of methods that may be performed by the controller will be described in more detail below.

Also depicted in FIG. 3, the validation panel may also comprise a tag/code reader 325 that extracts data that may be used to obtain information about information handling systems. For example, the code reader 325 may be used to scan (e.g., using a barcode or QR code reader) one or more service tags of the servers in the rack using a barcode reader. The scanned information may comprise (or may comprise a link to a site that comprises) a set of information about the scanned information handling system. For example, the information may contain:
(1) Unique service identifier
(2) Media Access Control (MAC) address(es)
(3) System information (e.g., system specifications, versioning information, etc.)
(4) System settings
(5) Wireless information (e.g., wireless network name (SSID); a security key or password for the network, if it is secured; device compatibility information (e.g., which wireless network protocols are supported (e.g., Bluetooth, NFC, Wi-Fi 6, etc.); Internet Protocol address configuration, if needed (e.g., IP address, subnet mask, etc.).
(6) Other information that may be helpful for connecting or for testing.

The validation panel 300 may also comprise a power module 320 for supply and/or managing power for the validation panel 300. In one or more embodiments, the power module may comprise a power source (e.g., a battery unit). Additionally or alternatively, the power module 320 may help manage power that is received from another source, such a Power-over-Ethernet via one or more of the ports 305, from a plug-in source (e.g., AC/DC plug-in), or from inductive powering.

### C. Validation Panel Method Embodiments

To address the validation issues discussed above, a validation panel or set of validation panels may be used to test a set of information handling systems in data center (which may be a computing datacenter, like an AI computation center, a data storage data center, a networking datacenter, or a combination thereof).

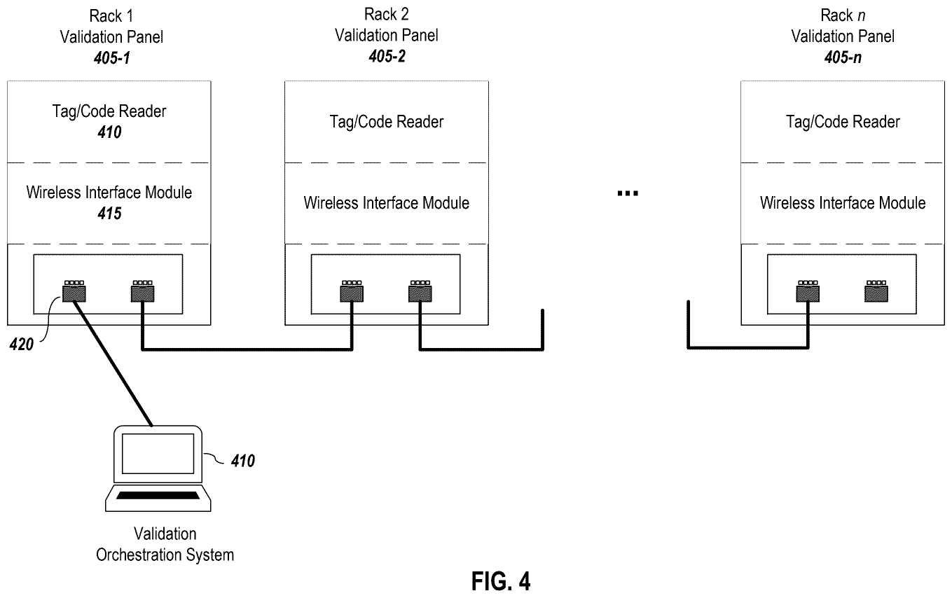

FIG. 4 depicts an example configuration for using a set of validation panels that may be used for testing information handling systems, according to embodiments of the present disclosure. In one or more embodiments, to validate a cluster of multiple racks containing numerous servers, validation panels 405 may be connected together (e.g., daisy-chained, as shown in FIG. 4). An operator may connect a validation system 410, such as a laptop, to a first or main validation panel 405-1 via the Ethernet port 420. From the validation system 410, the operator may orchestrate validation (e.g., by send commands or may have commands sent to a targeted rack through the main panel). For example, an operator may use the validation orchestrator system to select which tests are to be performed, which servers are to be tested, or a combination thereof. In one or more embodiments, the validation panel may also be configured to operate as the validation orchestrator system.

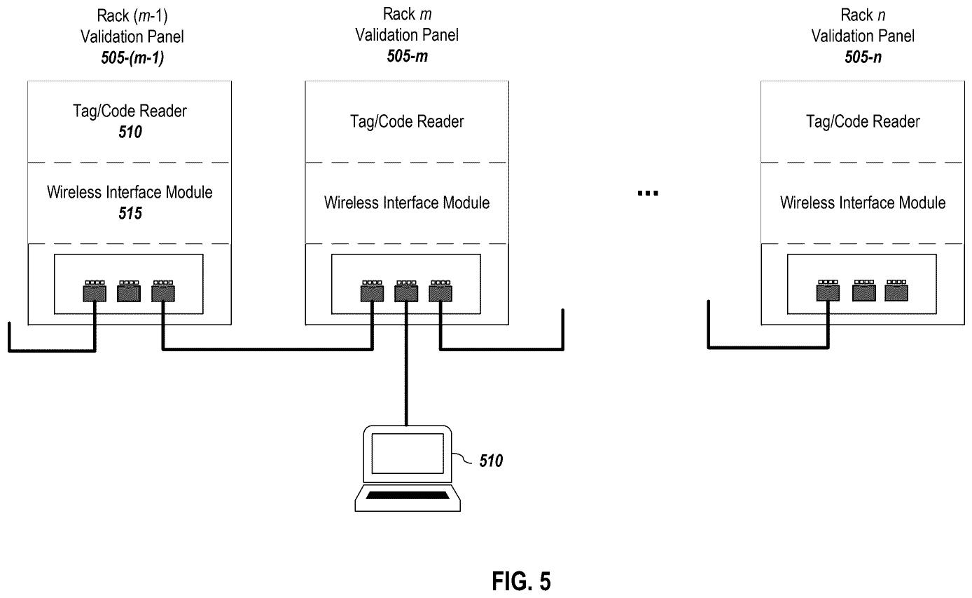

It shall be noted that different embodiments of validation panels and different connection configurations may be used. For example, FIG. 5 depicts an alternative configuration of a set of connected validation panels, according to embodiments of the present disclosure. It shall also be noted the number of validation panels involved may vary, including using only a signal validation panel.

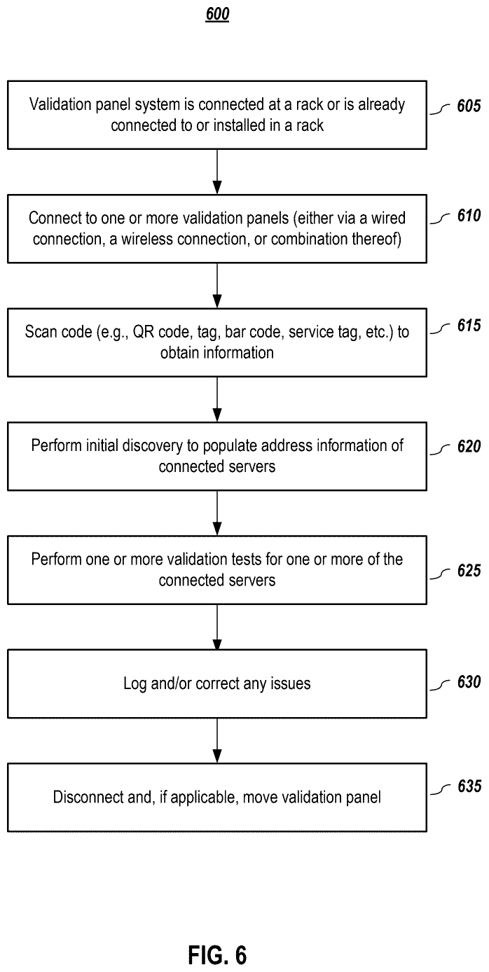

FIG. 6 depicts a methodology for using a validation panel system that facilitate testing/validating of one or more other information handling systems, according to embodiments of the present disclosure. Given a set of information handling systems that are to be tested/validated, a validation panel system may be connected at a rack or may already be connected to or installed (605) in a rack. Depending upon the scope of the number of information handling systems that are being tested/validated, one or more validation panels may be networked together—either via a wired connection, a wireless connection, or combination thereof. FIGS. 4 and 5 depicted examples of wired networking of validation panels.

For a validation panel, an operator may scan code or otherwise use the tag/code reader (e.g., reader 410 or 510 in FIGS. 4 and 5, respectively) to obtain information about the information handling systems (e.g., servers) in a region, such as on a rack. Examples explained in reference to FIG. 6 will comprise a validation panel being used to test a set of servers, which are all housed or connected to a rack—although it must be noted that other configurations may be used. For example, one validation panel may be used for information handling systems on just part of one rack, on more than one rack, or on no rack at all (e.g., a set of one or more separate information handling systems).

As noted previously, the tag/code may be a QR code, a tag, a barcode, a service tag, set of characters, etc. The information may comprise information for connecting to the servers on the rack. For example, in one or more embodiments, the tag/barcode reader reads a service tag in a pull tag of a system. The service tag may comprise a unique identifier for the system and may be used by the validation panel to connect to the system via a wireless connection (e.g., WiFi or Bluetooth). In one or more embodiments, the bar codes of servers in a rack that are read by the code reader may be stored in a cache. These codes may also be shared with a validation orchestration system (e.g., a connected laptop used by an operator) and/or with one or more validation panels. These service tags may additionally be checked against inventory lists to ensure that the correct hardware has been received and installed at the datacenter. In one or more embodiments, the code may directly include information about the information handling system (e.g., information used for connecting to the device wirelessly) but alternatively or additionally, the scanned information may include a link (such as a link to a website, which may be secured or hidden) that includes the connection information and/or addition information about the device, such as its build of materials, configuration, etc.

In this way, the validation system may easily communicatively couple to the servers that are to be tested/validated without requiring use of any of the network fabric of the datacenter.

In one or more embodiments, the validation system may perform (620) an initial discovery to populate address information of connected servers. For example, when a set of validation panels are connected together and a user is using one of the validation panels as a main panel (e.g., as depicted in FIG. 4 or in FIG. 5), the user system (e.g., computer 410 or 510) and/or the main validation panel may perform discovery to gather information from each of the connected panels. By way of illustration, if each validation panel 405 in FIG. 4 is wirelessly connected to a set of servers on the rack with the validation panel, the other panels (e.g., panels 405-2 through 405-n) may send information about each information handling system to which they are wirelessly connected to the main panel (e.g., panel 405-1). The information may be stored and/or managed by the main panel 405, the validation system 410, or both.

Given the network of information handling systems, the validation system may cause one or more validation tests to be performed (625) for one or more of the information handling systems that are connected via the validation panel(s). For example, a server may have one or more validation tests performed by running diagnostics—such as BV, SBR, and IST, along with other tests/validations, including third-party tests, such as Nvidia field diagnostics—to ensure the systems and components meet a customer's requirements. BV stands for “Build Verification,” and refers to a set of tests run on systems to verify that the build is stable and testable before it is released for further testing. SBR stands for “Secondary Bus Reset,” which is a test that stresses the PCIe links between the CPU and PCIe switch and also the PCIe switch to the GPUs. One of the purposes of such testing is to discover loose PCIe cable connectivity issues and/or faults. IST, which stands for Integrated Systems Testing, involves testing the integrated operation of various systems within a data center or server environment to ensure they work together as expected; it is an important phase in the commissioning process to validate the overall performance and reliability. Fewer or more tests may be performed.

Depending upon the implementation, the commands between or among validation may be handled in a variety of manners. In one or more embodiments, given the address information and topology of the connections, typical networking protocols or methodologies may be employed.

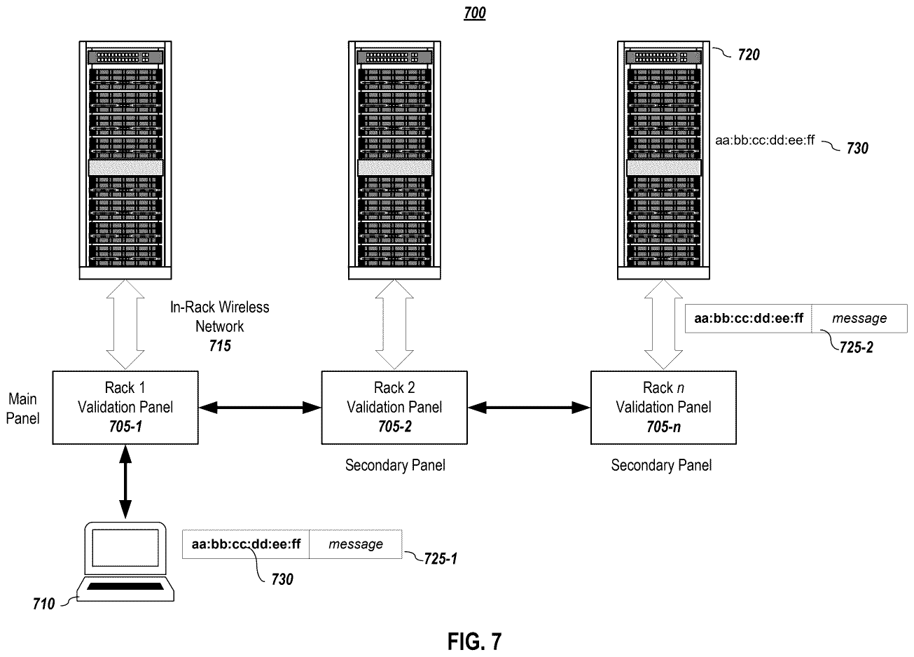

FIG. 7 depicts an alternative or additional methodology for handling data traffic, according to embodiments of the present disclosure. In one or more embodiments, each validation panel 705 may keep a listing of each information handling system to which it is directly connected (either wireless or via a wired connection). When a message (e.g., message 725-1) that originated from the validation system 710 is received by a validation panel, the validation panel may check whether the address 730 matches any of the addresses to which it is directly connected. That is, the controller of the main validation panel may extract the destination MAC address and compare it to its MAC table. If the address is not found in its table, the packets are forwarded downstream. The validation panel forwards the message to one or more other validation panels to which it is communicatively connected. Once the validation panel (i.e., validation panel 705-n in the example depicted in FIG. 7) that is connected to the recipient system that has the destination MAC address receives the message and recognizes that the message is addressed to one of its connected devices, the message 725-2 is delivered to the target server in the rack through an in-rack communication module of the wireless communications module of the validation panel system.

In one or more embodiments, other methods for data handling may be used. For example, if the validation system 710 knows all the validation panels 705 that are connected and all the systems connected to each of those panels, the validation system 710 may send a message with a hop count. In the example depicted in FIG. 7 (assuming that n=3), the validation system 710 may send the message 725-1 intended for device 730, in which the message includes a hop count that is decremented each time. Depending on the counting system, the message may be sent with 2 hop count. Validation panel 705-1 receives the message, decrements the hop count by 1 to 1, and forwards it to the next validation panel. Validation panel 705-2 receives the message, decrements the hop count by 1 to 0, and forward the message to the next validation panel. Validation panel 705-3 (n=3 in this example) receives the message with a zero (0) hop count. Since the hop count is zero, it does not decrement or forward the message to another validation system. Rather, it knows that the message is intended for one it is connected devices. It may broadcast the message to all the connected servers on the rack, and the intended recipient will recognize that its address matches the address of the message and will receive it. All other devices with mis-matched addresses may then drop the message. Alternatively, the validation panel may send the message as a unicast message directed to the recipient. One skilled in the art shall recognize a number of methods for handling network data traffic.

Returning to FIG. 6, in one or more embodiments, each validation panel, the main validation panel, the user validation orchestration system, or a combination thereof may log (630) the results. Any issues may be noted and corrected accordingly.

It shall be noted that certain steps of FIG. 6 may be skipped or optional depending on the implementation. For example, if the validation panel is just being held by a user, it need not be attached to a rack or other infrastructure. The validation panel may not be connecting to other validation panels. One skilled in the art shall recognize other steps that may be omitted, changed, or even added depending on the embodiment and/or the usage/deployment.

Once all testing/validation is completed, the validation panel may be disconnected (635) from the systems that it is connected to. Depending upon the embodiment of the validation panel that is used, the validation panel may be moved to a new location to test/validate more information handling systems. Alternatively, the validation panel may stay connected to the rack for future use.

One skilled in the art shall recognize that a validation panel, which may be an in-rack or on-rack hardware module, streamlines the validation process in large-scale deployment environments, reducing the need for duplicated resources, improves safety, reduces costs, and simplifies the validation of information handling systems in a large deployment. Providing validation from a rack-level perspective using wireless connectivity reduces cabling issues and costs—it removes the need for manually connecting RJ45 cables to network or management ports and using multiple validation servers to test each system individually. In one or more embodiments, validation panels are linked together into a network, allowing a tester to use a single system to run tests and aggregate the results, streamlining the entire process.

It is important to recognize the significance of advantages provided by the specialized validation panels. In site builds at are in the early stages of deployment, where the infrastructure is not fully functional, there is significant challenges to validating the systems. Even if the system were tested before shipping, damage during shipping or installation can occur. And, installation mismatches can create problems. Embodiments provide an early-stage, safe, and efficient ability to check validity without relying on infrastructure of the datacenter and/or if a vendor only have access to their own hardware and solutions. Embodiments also offer significant value to on-site validation teams by reducing time and resource demands, helping to ensure that validation processes are completed on schedule. For instance, clients can demand that the validation of a datacenter be completed within a very short time (maybe a week or two). Previously, on-site validation/service teams must run diagnostics and tests on each individual service, which is a process that can take approximately 10-12 hours—not counting the time needed to address any issues (e.g., replacing faulty hardware). Therefore, providing solutions for the on-site service/validation teams not only provide better and safer implementation but also dramatically enhance service quality.

### D. System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU)/controller, or hardware or software control logic, read only memory (ROM), and/or other types of memory. Additional components of the computing system may include one or more drives (e.g., hard disk drives, solid state drive, or both), one or more network ports for communicating with external devices as well as various input and output (I/O) devices. The computing system may also include one or more buses operable to transmit communications between the various hardware components.

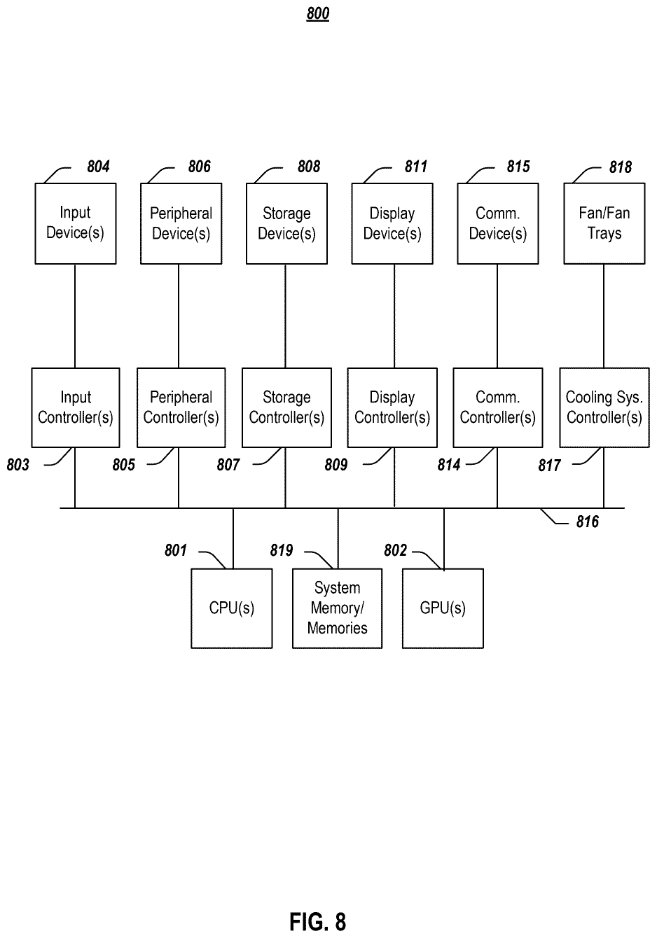

FIG. 8 depicts a simplified block diagram of an information handling system (or computing system), according to embodiments of the present disclosure. It will be understood that the functionalities shown for system 800 may operate to support various embodiments of a computing system—although it shall be understood that a computing system may be differently configured and include different components, including having fewer or more components as depicted in FIG. 8.

As illustrated in FIG. 8, the computing system 800 includes one or more CPUs 801 that provides computing resources and controls the computer. CPU 801 may be implemented with a microprocessor or the like and may also include one or more graphics processing units (GPU) 802 and/or a floating-point coprocessor for mathematical computations. In one or more embodiments, one or more GPUs 802 may be incorporated within the display controller 809, such as part of a graphics card or cards. In one or more embodiments, the system may alternatively or additionally include one or more data processing units (DPUs) (not shown). In the realm of datacenters and cloud computing, a DPU refers to a specialized processing unit designed to accelerate data processing tasks. DPUs are typically optimized for handling data-centric workloads such as networking, storage, security, and other tasks related to data processing and manipulation. DPUs often offload specific tasks from a main CPU, allowing for improved performance, efficiency, and scalability in data-intensive applications. They may include specialized hardware components and dedicated software to efficiently process and manage data flows within a system. The system 800 may also include a system memory 819, which may comprise RAM, ROM, or both.

A number of controllers and peripheral devices may also be provided, as shown in FIG. 8. An input controller 803 represents an interface to various input device(s) 804, such as a keyboard, mouse, touchscreen, stylus, microphone, camera, trackpad, display, etc. The computing system 800 may also include a storage controller 807 for interfacing with one or more storage devices 808 each of which includes a storage medium such as magnetic tape or disk, or an optical medium that might be used to record programs of instructions for operating systems, utilities, and applications, which may include embodiments of programs that implement various aspects of the present disclosure. Storage device(s) 808 may also be used to store processed data or data to be processed in accordance with the disclosure. The system 800 may also include a display controller 809 for providing an interface to a display device 811, which may be a cathode ray tube (CRT) display, a thin film transistor (TFT) display, organic light-emitting diode, electroluminescent panel, plasma panel, or any other type of display. The computing system 800 may also include one or more peripheral controllers or interfaces 805 for one or more peripherals 806. Examples of peripherals may include one or more printers, scanners, input devices, output devices, sensors, and the like. A communications controller 814 may interface with one or more communication devices 815, which enables the system 800 to connect to remote devices through any of a variety of networks including the Internet, a cloud resource (e.g., an Ethernet cloud, a Fibre Channel over Ethernet (FCoE)/Datacenter Bridging (DCB) cloud, etc.), a local area network (LAN), a wide area network (WAN), a storage area network (SAN) or through any suitable electromagnetic carrier signals including infrared signals. As shown in the depicted embodiment, the computing system 800 comprises one or more fans or fan trays 818 and a cooling subsystem controller or controllers 817 that monitors thermal temperature(s) of the system 800 (or components thereof) and operates the fans/fan trays 818 to help regulate the temperature.

In the illustrated system, all major system components may connect to a bus 816, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

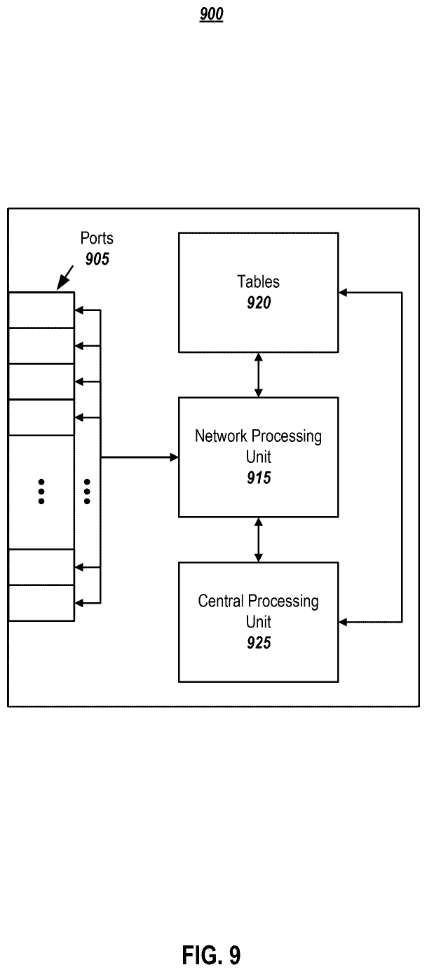

FIG. 9 depicts an alternative block diagram of an information handling system, according to embodiments of the present disclosure. It will be understood that the functionalities shown for system 900 may operate to support various embodiments of the present disclosure—although it shall be understood that such system may be differently configured and include different components, additional components, or fewer components.

The information handling system 900 may include a plurality of I/O ports 905, a network processing unit (NPU) 915, one or more tables 920, and a CPU 925. The system includes a power supply (not shown) and may also include other components, which are not shown for sake of simplicity.

In one or more embodiments, the I/O ports 905 may be connected via one or more cables to one or more other network devices or clients. The network processing unit 915 may use information included in the network data received at the node 900, as well as information stored in the tables 920, to identify a next device for the network data, among other possible activities. In one or more embodiments, a switching fabric may then schedule the network data for propagation through the node to an egress port for transmission to the next destination.

Aspects of the present disclosure may be encoded upon one or more non-transitory computer-readable media comprising one or more sequences of instructions, which, when executed by one or more processors or processing units, causes steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as compact discs (CDs) and holographic devices; magneto-optical media; and hardware devices that are specially configured to store or to store and execute program code, such as ASICs, PLDs, flash memory devices, other non-volatile memory devices (such as 3D XPoint-based devices), ROM, and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize that no computing system or programming language is critical to the practice of the present disclosure. One skilled in the art will also recognize that a number of the elements described above may be physically and/or functionally separated into modules and/or sub-modules or combined together.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A validation panel system comprising:
one or more wireless communication modules;
one or more controllers that orchestrate communication of the one or more wireless communication modules and with one or more rack information handling systems in a rack system, one or more other validation panel systems, a validation orchestrator system, or a combination thereof;
a reader that is configured to facilitate extraction of identifying data about one or more information handling systems from a set of one or more rack information handling systems in a rack associated with the validation panel system;
a power module that facilitates power to the validation panel system; and
a non-transitory controller-readable medium or media comprising one or more sets of instructions which, when executed by at least one of the one or more controllers, causes steps to be performed to facilitate validation of at least one of the one or more rack information handling systems without using wired networking infrastructure, if any, of the rack system.

2. The validation panel system of claim 1 further comprising:
one or more network ports that facilitate communication to one or more other validation panel systems, a validation orchestrator system, or a combination thereof.

3. The validation panel system of claim 2 wherein:
one network port facilitates connecting to the validation orchestrator system for coordinating one or more validation tests for one or more of the rack information handling systems; and
a second network port facilitates connecting to another validation panel system.

4. The validation panel system of claim 1 wherein the non-transitory controller-readable medium or media comprising one or more sets of instructions which, when executed by at least one of the one or more controllers, causes steps to be performed comprising:
receiving, via the reader of a validation panel system, data related to one or more rack information handling systems from a set of rack information handling systems;
using at least part of data obtained using the reader to connect via a wireless connection with one or more rack information handling systems from a set of rack information handling systems; and
facilitating one or more validations tests to at least of the one of one or more rack information handling systems from a set of rack information handling systems using at least one of the wireless connections.

5. The validation panel system of claim 1 further comprising:
responsive to the validation panel system being communicatively coupled to one or more other validation panel systems that are communicatively coupled to one or more additional sets of one or more rack information handling systems on other rack systems, transmitting from the validation panel system one or more commands related to validation to one or more of the one or more other validation panel systems, in which the one or more commands are intended for at least one rack information handling system from the one or more additional sets of one or more rack information handling systems on other rack systems.

6. The validation panel system of claim 1 wherein the validation panel system comprises a form factor to facilitate easy attaching and removal from the rack system without having to be fully installed within a rack space of the rack system.

7. A method comprising:
receiving, via a code reader of a validation panel, data related to one or more information handling systems from a set of information handling systems, in which the validation panel comprises:
one or more wireless communication modules;
one or more controllers that orchestrates communication for the one or more wireless communication modules;
the code reader;
a power module that facilitates power to the validation system; and
a non-transitory computer-readable medium or media comprising one or more sets of instructions which, when executed by at least one of the one or more controllers, causes steps to be performed;
using at least part of data obtained using the code reader to connect via a wireless connection with one or more information handling systems from a set of information handling systems; and
facilitating one or more validations tests to at least of the one of one or more information handling systems from a set of information handling systems.

8. The method of claim 7 wherein the set of information handling systems are a set of servers installed within a rack system and the validation panel connects wirelessly to one or more of the servers without utilizing wired networking infrastructure, if any, of the rack system.

9. The method of claim 7 wherein the step of facilitating one or more validations tests to at least of the one of one or more information handling systems from a set of information handling systems comprises:
connecting to a validation system that coordinates validation of at least of the one of one or more information handling systems from a set of information handling systems.

10. The method of claim 9 wherein the validation panel further comprises:
one or more network ports that facilitate communication, via one of the network ports and the controller, with the validation system.

11. The method of claim 7 further comprising:
facilitating an initial discovery to populate identifying information related to one or more peer validation panels, one or more additional sets of one or more information handling systems, or a combination thereof.

12. A validation panel system comprising:
one or more wireless communication modules;
one or more controllers that orchestrate communication of the one or more wireless communication modules and with one or more information handling systems, one or more other validation panel systems, or a combination thereof;
a code reader that is configured to facilitate extraction of identifying data about one or more information handling systems from a set of one or more information handling systems in a region;
a power module that facilitates power to the validation panel system; and
a non-transitory controller-readable medium or media comprising one or more sets of instructions which, when executed by at least one of the one or more controllers, causes steps to be performed to facilitate validation of at least one of the one or more information handling systems.

13. The validation panel system of claim 12 further comprising:
one or more network ports that facilitate communication connection to one or more other validation panel systems, one or more information handling systems, or a combination thereof.

14. The validation panel system of claim 13 wherein:
one network port facilitates connecting to an information handling system that is a validation system for coordinating one or more validation tests for one or more of the information handling systems from the set of information handling systems; and
a second network port facilitates connecting to another validation panel system.

15. The validation panel system of claim 12 wherein the power system comprises or supports:
one or more batteries;
receipt of power from an external power source;
receipt of power from an inductive power source; and
a combination thereof.

16. The validation panel system of claim 15 further comprising:
one or more network ports that facilitate communication via physical connection to one or more other validation panel systems, one or more other information handling systems, or a combination thereof,
wherein the power system supports power-over-Ethernet in which power is received via at least one of the one or more network ports.

17. The validation panel system of claim 12 wherein the non-transitory controller-readable medium or media comprising one or more sets of instructions which, when executed by at least one of the one or more controllers, causes steps to be performed comprising:
receiving, via the code reader, identifying data about one or more of the information handling systems from the set of information handling systems;
using at least some of the identifying data to connect via a wireless connection with at least one of the one or more information handling systems from the set of information handling systems; and
performing one or more validations tests on the at least one of the one or more information handling systems from the set of information handling systems.

18. The validation panel system of claim 12 further comprising:
responsive to the validation panel system being communicatively coupled to one or more peer validation panel systems that are communicatively coupled to one or more additional sets of one or more information handling systems, transmitting from the validation panel system one or more commands related to validation to one or more peer validation panel systems for at least one information handling system from the one or more additional sets of information handling systems.

19. The validation panel system of claim 18 wherein the non-transitory controller-readable medium or media comprising one or more sets of instructions which, when executed by at least one of the one or more controllers, causes steps to be performed comprising:
facilitating an initial discovery to populate identifying information of the one or more peer validation panel systems, the one or more additional sets of one or more information handling systems, or a combination thereof.

20. The validation system of claim 12 wherein the region is a rack.
